(19) United States
(12) Patent Application Publication
(10) Pub. No.: US 2014/0255899 A1
(43) Pub. Date: Sep. 11, 2014

(54) COMMUNICATION TABLET FOR TEACHING

(71) Applicant: Franck POULLAIN, L'Hay-les-Roses (FR)

(72) Inventor: Franck Poullain, L'Hay-les-Roses (FR)

(21) Appl. No.: 14/351,052

(22) PCT Filed: Oct. 8, 2012
(86) PCT No.: PCT/FR2012/052282

§ 371 Date: Apr. 10, 2014

(30) Foreign Application Priority Data
Oct. 11, 2011 (FR) 1159141

(51) Int. Cl. G09B 5/12

(52) U.S. Cl. CPC G09B 5/125
USPC 434/351

(57) ABSTRACT

A teaching device formed by the combination of a wireless communication terminal located in a classroom of an educational establishment and a set of communication tablets that each belong to a student or a teacher of the class. The tablet has two rigid flaps that are articulated about a hinge which is hollow in order to store a stylus therein and is able to rotate through 360°. Each of the two flaps has an impact- and liquid-resistant outer face and an impact-and liquid-resistant inner face and a screen for reading and writing manually by means of a stylus.

### CROSS-REFERENCE TO RELATED APPLICATIONS

This application is a U.S. National Phase Patent Application based on International Application No. PCT/FR2012/052282 filed Oct. 8, 2012, which claims priority to French Patent Application No. 1159141 filed Oct. 11, 2011, the entire disclosures of which are hereby explicitly incorporated by reference herein.

### BACKGROUND OF THE INVENTION

1. Field of the Invention

The present invention relates to a teaching apparatus formed by the combination of a wireless communication terminal located in a classroom of an educational institution and a set of communication tablets each belonging to a student in or a teacher of the class.

2. Description of the Related Art

Communication tablets are known to the general public and are also used in educational institutions. These tablets have a limited format close to the A5 format, are fragile and sensitive to impacts and liquids, have a liquid crystal screen that is energy-intensive and causes eye strain with long reading, have a writing stylus that is inconvenient or necessitates reading with the hand raised, have a wireless communication system utilizing a frequency range (2.45 GHz) that is presumed to be genotoxic and that, in a classroom where everyone is using a tablet, creates a permanent electromagnetic fog whose long-term effects are unknown, have a limited autonomy of only a few days, and have no security system to identify the user and secure the communication flow. The A4 large-format or A4 two-page models add weight to the above disadvantages. The models equipped with a stylus do not offer writing comfort similar to that of writing on paper.

### SUMMARY OF THE INVENTION

The present invention provides a communication tablet for teaching. One object of the invention is to propose a teaching apparatus whose tablets do not have the disadvantages of prior devices. Another object of the invention is to propose a teaching apparatus for secondary-level teaching, in middle schools and high schools, that relieves students of the need to carry books, notebooks and writing utensils, works with the academic ecosystem, and is energy-saving and in compliance with rules relating to the electromagnetic environment of the students.

The subject matter of the invention is, therefore, a teaching apparatus for teaching in an institution such as a middle school or high school, characterized in that it comprises:
on the one hand, a wireless communication terminal located in a room of the institution, particularly in a classroom thereof, and cooperating with a server belonging to said institution and ensuring control of said communication terminal, and
on the other hand, a set of electronic communication tablets respectively belonging to a user of the room, particularly to a student in or teacher of the class, and each comprising user identification means and a wireless communication interface permitting low-power, short-range communication between the tablets and/or between a tablet and the communication terminal,
each of the communication tablets being formed by two rigid isofunctional panels that are articulated on a hinge able to rotate 360° and that each have an impact- and splash-resistant outer face and an inner face equipped with a touch screen for reading and writing manually by means of a stylus using an electronic ink display, as well as, in their respective interior portions, data communication and processing means and/or data storage memories and/or batteries.

The invention also concerns a communication tablet for teaching that is an integral part of such an apparatus and is characterized in that it comprises two rigid panels articulated on a hinge able to rotate 360°, each of the two panels having an impact- and splash-resistant outer face and an impact- and splash-resistant inner face comprising a screen for reading and writing manually by means of a stylus.

According to another characteristic, the hinge is hollow so that a stylus can be stored inside it and has connectors capable of receiving a jack-type plug or any other connector conforming to the USB electrical standard and capable of communicating according to said standard, recharging the tablet with electricity and connecting thereto any type of USB peripheral. The use of jack-style connectors facilitates cable connection for the blind and for children, since this type of connector is self-centering and does not require additional manipulation to determine the orientation of the connector.

Each of the two reading and writing screens may be provided at its borders with touch navigation tabs for selecting the subject being taught and the activity performed by the user.

In an advantageous manner, in its version for the blind, the reading and writing screens have embossed lines for guiding the finger or hand of the blind user, and Braille characters identifying new lines and the navigation tabs.

Advantageously, the writing screen comprises a rolling pad and the stylus has a ball made of hard rubber or any other material suitable for rolling over the pad, which restores to the user the sensation of writing on a pad of paper with a ballpoint pen.

In an advantageous manner, wireless communication with the tablet is provided in a frequency range of 868 to 915 MHz, with a distance range of about 10 m and a power of 1 mW or less, the tablet remaining in continuous listening mode and transmitting only on explicit instructions.

Advantageously, the outer surfaces of the panels and the inner surfaces surrounding the screens are covered with a solar film for producing electricity.

In an advantageous manner, the tablet can have on the outside of one of its panels a screen protector that can be snapped together to form a stand for maintaining the panel in a tilted position.

The stylus may be provided with a battery and antenna and with a jack-type connector, or any other connector conforming to the USB electrical standard, for transmitting the pressure exerted on the writing tip via electromagnetic waves and via wired link, respectively.

In one form thereof, the present invention provides a teaching apparatus for teaching in an institution such as a middle school or a high school, characterized in that it includes: on the one hand, a wireless communication terminal located in a room of the institution, particularly in a classroom thereof, and cooperating with a server belonging to said institution and serving to monitor said communication terminal, and on the other hand, a set of electronic communication tablets belonging respectively to a user of the room, particularly to a student in or teacher of the class, and each including user identification means and a wireless communication interface permitting low-power, short-range communication between the tablets and/or between a tablet and the communication terminal, each of the communication tablets being formed by two isofunctional rigid panels that are articulated on a hinge able to rotate 360° and that each have an impact-resistant outer face and an inner face equipped with a touch screen for reading and writing manually by means of a stylus using an electronic ink display, as well as, in their respective interior portions, data communication and processing means and/or data storage memories and/or batteries.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 is a front view in open position of the tablet according to the invention;

FIG. 2 is a perspective view of the right side of the tablet;

FIG. 3 is a perspective back view of the tablet;

FIG. 4 is a perspective view of the tablet from above;

FIG. 5 is a perspective front view with keyboard and mouse;

FIG. 6 is a side view of the tablet in open landscape position, with a stylus in the hinge;

FIG. 7 is a cross-sectional view of the tablet in open portrait position, leaning on its foot;

FIG. 8 is a cross-sectional view of the tablet in closed position with the stylus in the hinge;

FIG. 9 is a cross-sectional view in open position;

FIG. 10 is a cross-sectional view in notepad position;

FIG. 11 is a cross-sectional view in open position with the protective cover on the left panel;

FIG. 12 is a cross-sectional view in notepad position with the protective cover on the left panel;

FIG. 13 is a cross-sectional view in open position with the cover serving as a stand in low position;

FIG. 14 is a cross-sectional view in open position with the cover serving as a stand in high position;

FIG. 15 is a perspective side view in open position with the cover serving as a stand in high position;

FIG. 16 is a back view in open position with the cover serving as a stand in high position;

FIG. 17 is a view of the protective cover when it is flat against one of the sides of the left panel;

FIG. 18 is a longitudinal sectional view of the stylus with the ball poised on the multilayer surface;

FIG. 19 is a front view in open position with the embossed guide lines for the blind;

FIG. 20 are perspective views of the tablet open (a, b) and closed (c) with the elastic closing band in its various positions;

FIG. 21 is a partial sectional view of the stylus with connector, battery and antenna;

FIG. 22 is a layout of a classroom with an arrangement of forward-facing tables; and

FIG. 23 is a situational example of the tablets and the communication terminal in the ecosystem.

Corresponding reference characters indicate corresponding parts throughout the several views. Although the exemplifications set out herein illustrate embodiments of the invention, the embodiments disclosed below are not intended to be exhaustive or to be construed as limiting the scope of the invention to the precise forms disclosed.

### DETAILED DESCRIPTION

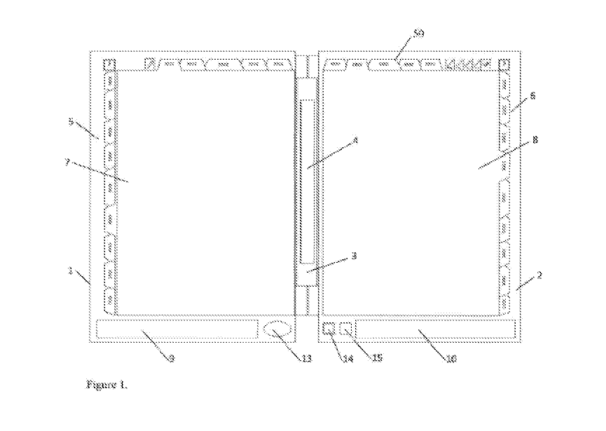

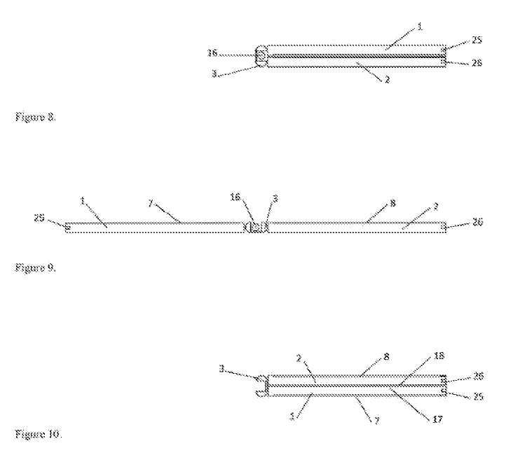

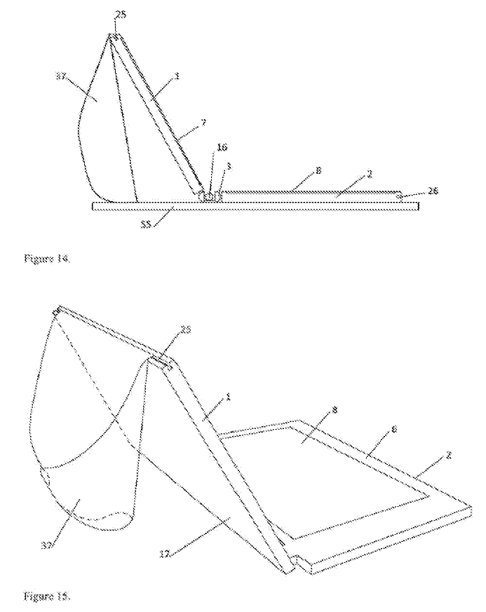

The communication tablet (FIGS. 1 to 4) has a left panel 1, a right panel 2 and a hinge 3. Each of the panels 1, 2 has an impact- and splash-resistant outer face, respectively 17, 18, and an inner face, respectively 5, 6, having an impact- and splash-resistant reading and writing screen, respectively 7, 8. Writing on the screen 7, 8 is done manually, by means of a stylus 16. The hinge 3 is provided on the inside with a cavity 4 capable of receiving the stylus. The hinge 3 is wide enough so that the two panels 1, 2 articulate independently from each other. When the tablet is closed, the inner faces 5, 6 of the panels 1, 2 are facing each other and the cavity 4 is closed by the narrow sides of the two panels 1, 2 (FIG. 8), the stylus 16 thus being locked in place inside the cavity 4. When the tablet is open (FIG. 11), both panels 1, 2 lie flat, the screens 7, 8 are accessible for reading and writing, and the cavity 4 is open, giving access to the stylus 16.

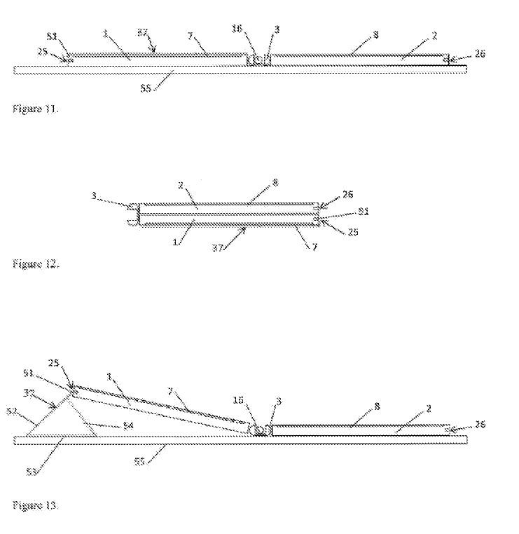

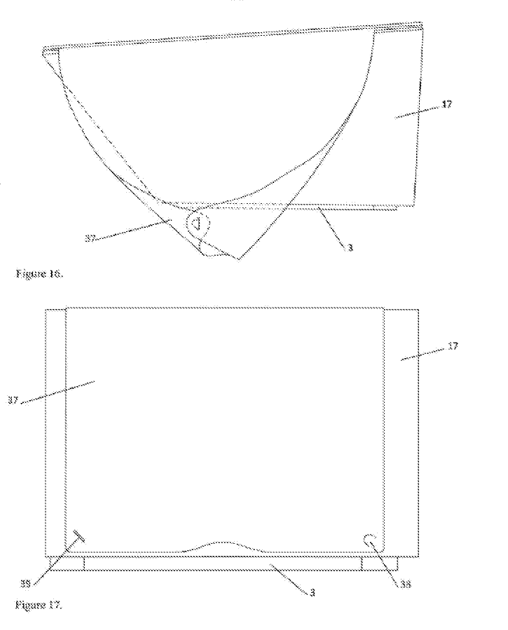

When the tablet is folded into notepad position (FIG. 10), that is, when one of the panels 2 has rotated 360° relative to the other panel 1, the outer faces 17, 18 of the two panels are facing each other and the inner faces 5, 6 are on the outside. The hinge 3 is then open to the outside, its cavity 4 being accessible. The tablet can be used as a notepad, where only one screen 8—or 7, in the case of use by a left-handed person—is useful for reading or writing. To protect the other screen 7, a screen protector 37 is put in place (FIG. 11, 12). This optional screen protector 37 has on one edge a trim piece 51 that can be inserted in a slot 25, 26 provided on the edge of the panel 1, 2 (FIGS. 9, 15). The screen protector 37 can be formed by three strips 52, 53, 54 articulated two by two and capable of being folded into a trihedron (FIG. 13), to form a stand for the panel 2 when the tablet is placed on a flat surface 55 such as a table.

This screen protector 37 can be provided with a solar film that will serve as an additional energy source for powering the tablet or recharging its batteries. This screen protector can be attached to either panel 7 or panel 8, depending on whether the student is left-handed or right-handed.

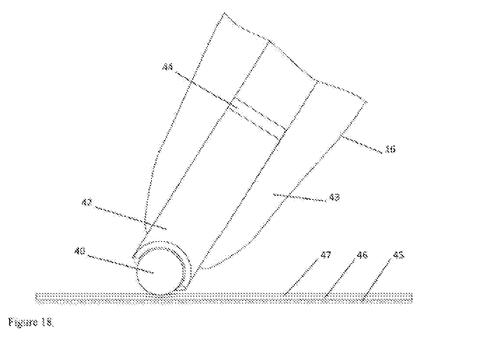

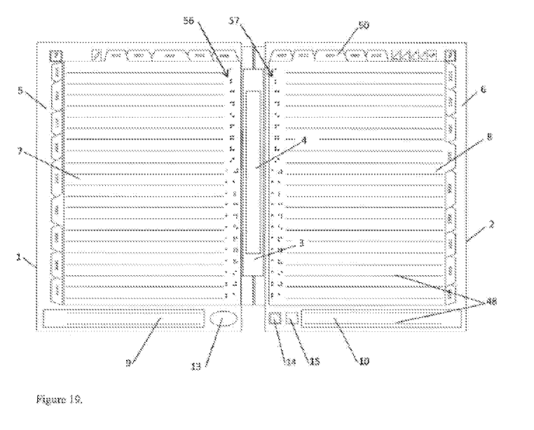

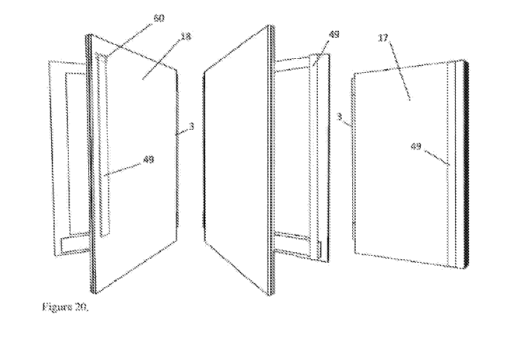

If the user of the tablet wishes to have one screen 8 lie flat for writing and one screen 7 be raised for reading in a position much closer to the vertical than that shown in FIG. 6, then he uses as a stand for panel 1 a foot 33 that is retained by a strap 35 and is able to fold into the back of the panel 1. He can also roll up the screen protector 37, when it is inserted into the slot 25, to make it into a stand for the screen 1 (FIGS. 14, 15, 16). The two free corners of the screen protector 37 respectively comprise a lug 38 and a slit 39 (FIG. 17) to enable them to be snapped together.

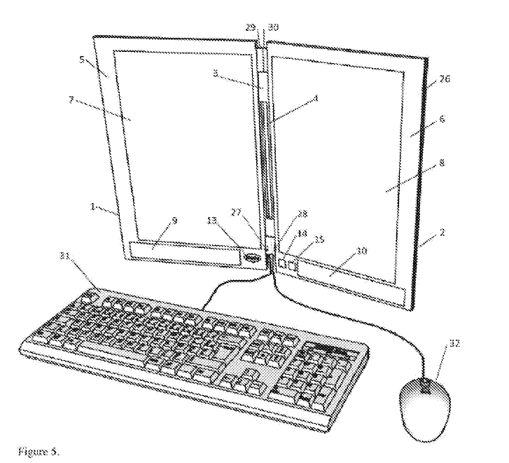

If the user wants to have both screens 7, 8 in vertical position, he opens the tablet, forming a dihedron with the panels 1, 2, and places the bottom edges of the panels 1, 2 on the flat surface 55 in the manner of a folding screen (FIG. 5). He can plug a keyboard and a mouse into the USB connectors 27, 28.

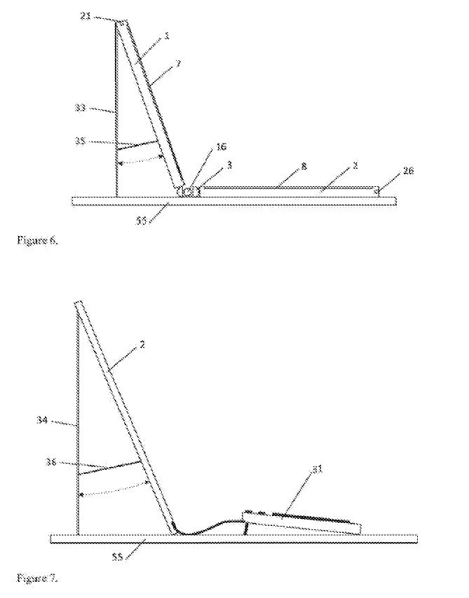

If the user wishes to have both screens 7, 8 in a single oblique plane close to the vertical, he uses a collapsible foot 34, which can be folded into the hinge 3 (FIG. 7) and is retained by a strap 36.

A foot 19 can be used in the same fashion on a model of the tablet (FIG. 3) that has a foot in the back of the panel 1 instead of in the hinge 3. A cavity 20 is provided for extracting the foot 19.

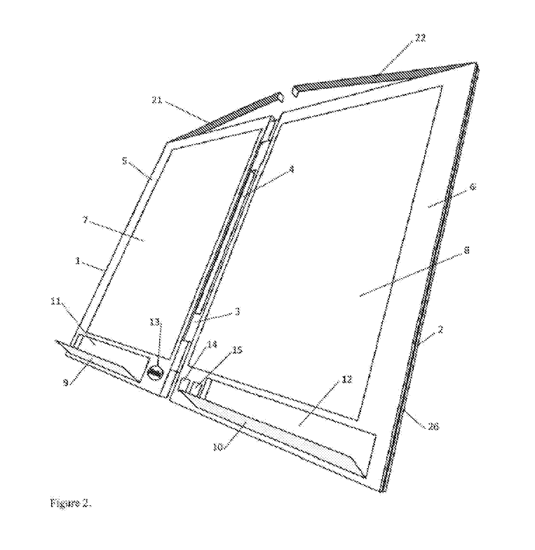

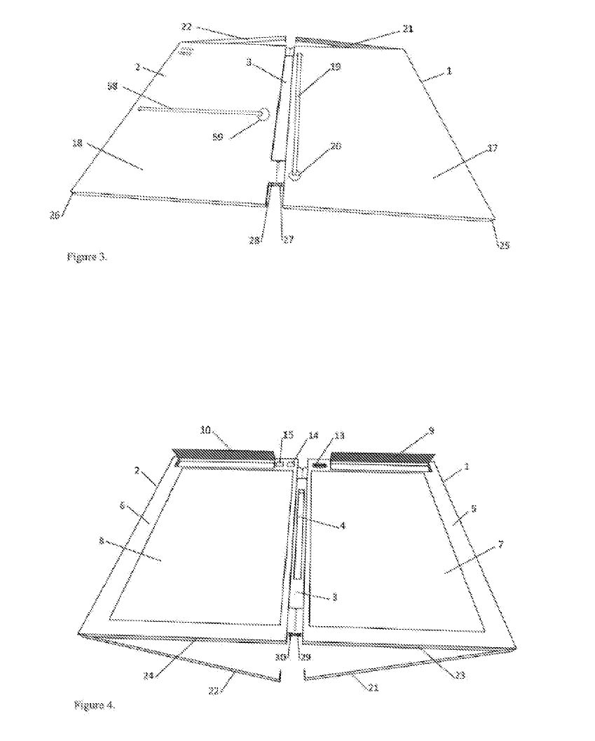

Each of the panels 1, 2 has in its lower portion a tray 11, 12 that is closed by means of a flap 9, 10. When flipped over the tray 11, 12, this flap 9, 10 also serves as a rest for the student's hand when he is writing on the lower portion of the screen 7, 8 (FIGS. 2, 4).

This tray 11, 12 advantageously also provides a space for stowing accessories, such as a compass or a USB cable.

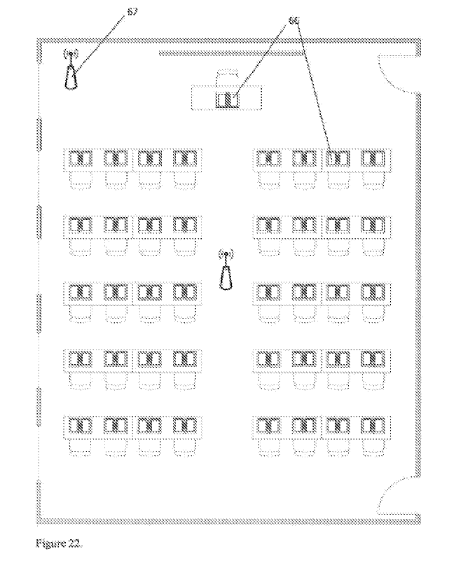

The tablet is held in closed position (FIG. 20) by means of an elastic band 49 attached to the back of the panel 2 by means of a catch 60. This band also holds the stylus 16 in its storage space 4. Keeping the tablet in closed position by means of this band prevents the stylus 16 from coming out of its storage space 4 and thus being lost in the event of mishandling by the student, or the screens 7, 8 from being altered if the device is dropped.

Each of the panels 1, 2 has, in the vicinity of the hinge 3, a connector 27, 28, 29, 30 capable of receiving a jack-type plug or any other type of connector conforming to the USB electrical standard (FIGS. 3, 4) and capable of communicating according to that standard, recharging the tablet with electricity, and connecting any type of USB peripheral to it. This connector 27, 28, 29, 30 is set back relative to the bottom edge of the panel 1, 2 to enable a USB cable to be connected while keeping the tablet standing up (FIG. 5, 7) on a flat surface 55. In the example of FIG. 5, the tablet is connected to a keyboard 31 and a mouse 32 via a USB cable. Since these connectors are in a concavity, they are less likely to be damaged, for example if the device is dropped, than if they were placed on the sides of the panels. Similarly, if these connectors were on the sides of the panels, a student could disconnect or twist the cables out of spite. Because the cables are in the hinge, they become hard to access when the tablet is in folding-screen position and are therefore less subject to mischief on the part of students.

Each of the screens 7, 8 comprises at least three layers (FIG. 18): a bottom layer 45 which is the display layer, an intermediate layer 46 and a top layer 47. The bottom layer 45 is formed by an electronic ink display or any other display technology offering similar characteristics: low power consumption, equivalent display quality to paper, and impact resistance. Of the intermediate layer 46 and the top layer 47, one—it does not matter which—is a writing surface for use with the stylus 16 and the other is a rolling pad to give the user the sensation of writing on a notepad.

The stylus 16 (FIG. 21) has an outer body 43 and an axial pin 42. The pin 42 has at its protruding end a ball 40 made of hard rubber or any other material capable of rolling over the top layer 47 of the screen 7, 8 and creating a sufficient rolling depression to furnish a writing sensation similar to that of writing on a notepad.

The stylus 16 has a ball 40 made of hard rubber or any other material that is actually able to roll, and not just slide, over the rolling pad 47: the rubber or other material catches on the coating of the pad and produces a resistance equivalent to that of writing on a sheet of paper with a ballpoint pen.

The thickness of the rolling pad 47 reproduces the sensation of thickness of several sheets of paper and thus procures the same writing comfort as that of writing on a notepad with a ballpoint pen.

In the exemplary embodiment of FIG. 21, the stylus 16 is capable of recording information relating to the pressure exerted on the stylus by the hand. This information can then be transmitted to the tablet if the user so desires, either via an antenna 64 integral to the stylus or via a cable connecting the USB port of the stylus to the tablet through one of the USB connectors of the hinge 27, 28, 29, 30. The stylus has a female connector 61 at its other end, in the form of a jack socket or any other type of connector conforming to the USB electrical standard. This information relating to pressure is not necessary for writing on the tablet, but it makes it possible to recreate, via software, line thicknesses that are proportional to the pressure recorded by the stylus. The use of the cable does not cause any power consumption, in contrast to radio transmission, which pulses its energy into the battery 65 integral to the stylus. The battery 65 of the stylus recharges automatically when the stylus 16 is connected to the tablet. It should be noted that the power of the electromagnetic radiation emitted by the stylus is much lower due to its proximity to the tablet. The stylus 16 includes a cap 62 attached by a thread 63.

The stylus 16 is provided with a battery 65 and an antenna 64, and with a connector 61 in the form of a jack socket or any other type of connector conforming to the USB electrical standard, to transmit the pressure exerted on the writing tip 40 via electromagnetic waves and via wired link, respectively.

Each of the panels 1, 2 of the tablet has a certain thickness, and the interior space contains the data processing and communication means, the data storage memories, and batteries. The upper portion of this interior space is formed by two compartments 23, 24 made accessible by top covers 21 and 22 (FIG. 4). These compartments 23, 24 can be used to stow flat work utensils such as a protractor, a square and a ruler, for example. Advantageously, the screen 7, 8 comprises a top layer 47 used as a rolling pad, an intermediate layer 46 used to capture the movements of the ball 40 and the user's fingers, and a bottom layer that displays the signs written by means of the ball 40, using electronic ink technology or any other display technology offering similar characteristics: low power consumption, paper display quality and impact resistance.

The screen protector 37, the outer surfaces 17, 18 of the panels 1, 2, and the perimeters 5, 6 of the screens 7, 8 can be covered with solar films. There are multiple advantages to the use of solar films: batteries can be smaller and lighter, the risk of depletion of the batteries is reduced, and the amount of rare metals in the batteries is limited, thus preserving the environment.

Outside of the area set aside for reading and writing on each of the screens 7, 8, the upper and outer borders of each screen have touch navigation tabs 50 that can be used, for example, to select the subject being taught, dictionaries, reference books stored in memory, personal data, or data relating to the middle school or high school.

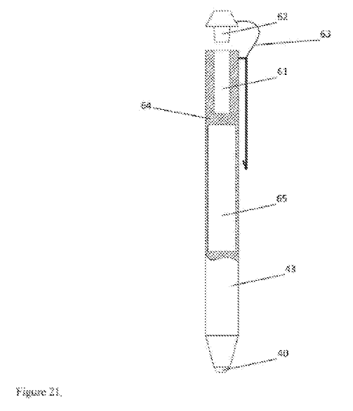

In its version for the blind (FIG. 19), the tablet has on the screens 7, 8, on the one hand, embossed lines 48 for guiding the user's finger or hand, and, on the other hand, a line number in Braille characters 56, 57 identifying a new line, on the left or on the right. Braille characters are also provided on the navigation tabs 50: letters on the upper border of the screen, line numbers in the outer border of the screen.

The communication tablet for teaching is operated as follows (FIG. 1). First, the tablet is turned on by actuating the ON/OFF button 13. It is then activated by means of a contactless individual identification card 68 (FIG. 23) of the student or teacher on sensor 14 and, if applicable, a digital fingerprint on sensor 15. The subject being studied (history, mathematics, for example) is selected via a tab 50 on the outer border of screen 8, and the activity (dictation, monitoring, dictionary, for example) is selected via a tab 50 on the upper border of screen 7, 8. A right-handed student has the reference document appear on the left-hand screen 7 and writes on the right-hand screen 8, whereas a left-handed student has the reference document appear on screen 8 and writes on screen 7.

The tablet is equipped with a wireless communication interface permitting low-power (1 mW) communication at a short range of about 10 m, from tablet to tablet or from tablet to dedicated terminal, with a number of recipients ranging up to 40 (the number of students in a class) or even more, to meet the requirements of an examination room, and in a frequency range of 868 to 915 MHz, which is considered to be less harmful to health than the 2.45 GHz range used for WiFi communication and microwave ovens. This communication takes place via random transmission to avoid simultaneous transmission from all the tablets in a classroom, which would generate more electromagnetic energy. The wireless communication interface of the tablet is in receive mode by default and initiates transmission only on explicit instructions from the user or the teacher.

Outside the classroom, the tablet can be connected to a computer by means of a USB cable plugged into one of the connectors 27, 28, 29, 30. The tablet contains an audio signal processor for teaching languages and music. The connectors 27, 28, 29, 30 are preferably capable of receiving jack-type plugs, which are less fragile and more convenient to use in a scholastic environment. The USB cable connection makes it possible to transfer files when no wireless communication is available, copy files to or from a tablet, update files or download files, connect to a computer, access the Internet, connect to a printer, and connect to an analog device for oral or music instruction. The connectors 27, 28, 29, 30 are also used to recharge the tablet's internal batteries.

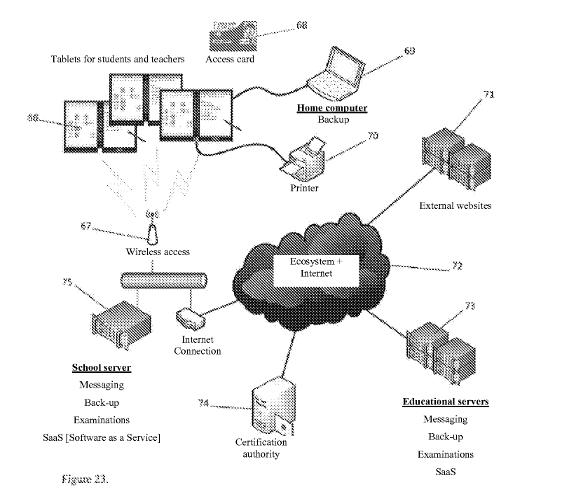

The tablet 66 is capable of evolving in an ecosystem essentially composed of one wireless communication terminal 67 per classroom (FIG. 22), a server 75 belonging to the middle school or high school controlling the wireless communication terminals in the classrooms, the student's computer 69 and printer at home 70 (FIG. 23), servers 71 accessible via the Internet 72, certification authorities 74 and sites accessible via the Internet and accredited by the supervisory authorities 73.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1-11. (canceled)

12. A teaching apparatus for use in teaching in an institution such as a middle school or a high school, said teaching apparatus comprising:
a wireless communication terminal, said wireless communication terminal cooperating with a server, said server monitoring said wireless communication terminal;
a plurality of electronic communication tablets each respectively associated with at least one of a student and a teacher of the class, each said tablet comprising user identification means and a wireless communication interface, said wireless communication interface permitting communication between at least one of: (1) the tablets and (2) a tablet and said communication terminal; and
each communication tablet further comprising two rigid panels articulated to one another via a hinge and able to rotate 360°, each panel having an impact-resistant outer face and an inner face including a touch screen for reading and writing manually by means of a stylus using an electronic ink display, and an interior portion including at least one of data communication and processing means, data storage memories, and batteries.

13. The teaching apparatus of claim 12, further comprising a stylus, and wherein said hinge of said communication tablet includes a hollow portion, said stylus receivable within said hollow portion.

14. The teaching apparatus of claim 12, wherein said hinge of the communication tablet includes at least one connector for receiving a USB electrical standard device for at least one of recharging said tablet with electricity and connecting said tablet with a USB peripheral.

15. The teaching apparatus of claim 12, wherein each of said screens of said communication tablet has a border including at least one navigation touch tab for use in selecting at least one of a subject being taught and an activity to be performed by a user.

16. The teaching apparatus of claim 12, wherein said communication tablet is configured for a blind user, and said screens of said communication tablet include embossed lines for guiding a finger of the user, and Braille characters.

17. The teaching apparatus of claim 12, further comprising a stylus including a ball tip, and wherein the screen of said communication tablet has an integral rolling pad which, when used with said ball tip of said stylus, restores to a user a sensation of writing on a pad of paper with a ballpoint pen.

18. The teaching apparatus of claim 12, wherein wireless communication between said communication tablets is provided in a frequency range of 868 to 915 MHz and a power of 1 mW or less, said tablets remaining in a continuous listening mode and transmitting only on receipt of an instruction.

19. The teaching apparatus of claim 12, wherein each panel includes an outer surface, an inner surface surrounding said screen, and a screen protector, each of said outer surface, inner surface, and screen protector covered with a solar film for the production of electricity.

20. The teaching apparatus of claim 12, further comprising a screen protector inserted in a slot of one of said panels, said screen protector including portions that can be snapped to one another to form a stand for maintaining said panel in a tilted position.

21. The teaching apparatus of claim 12, further comprising a stylus with a writing tip, said stylus further comprising a battery, an antenna, and a connector for one of a plug or a connector conforming to the USB electrical standard for use in transmitting pressure exerted on said writing tip via electromagnetic waves.
